(19) United States
(12) Patent Application Publication
(10) Pub. No.: US 2013/0229286 A1
(43) Pub. Date: Sep. 5, 2013

(54) SAFETY BARRIER ALERT

(71) Applicant: Diego Sanchez, Cypress, TX (US)

(72) Inventor: Diego Sanchez, Cypress, TX (US)

(73) Assignee: LANDMARK GRAPHICS CORPORATION, Houston, TX (US)

(21) Appl. No.: 13/883,625

(22) PCT Filed: Apr. 4, 2011
(86) PCT No.: PCT/US2011/031101

§ 371 Date: May 6, 2013

(51) Int. Cl. G08B 21/02

(52) U.S. Cl. CPC G08B 21/02
USPC 340/853.1

(57) ABSTRACT

At least some of the illustrative embodiments are a non-transitory machine-readable storage medium including executable instructions that, when executed, cause one or more processors to receive drilling rig safety barrier data based on conditions of safety barriers in one or more drilling rigs. The one or more processors are further caused to identify, based on the drilling rig of safety barrier data, an impending invalidation of at least one of the safety barriers. The one or more processors are further caused to identify, based on the impending invalidation, one or more profiles for alert, and output, based on the one or more profiles, an alert of impending safety barrier invalidation.

### BACKGROUND

A well is a pathway through subsurface formations to a reservoir target potentially containing hydrocarbons. If a commercial quantity of hydrocarbons is discovered, a casing is set and completion equipment is installed to control the flow of hydrocarbons to the surface safely while preventing undesired flow through other paths for the life of the well.

Devising drilling rig safety protocol that reduces the potential for injury and also reduces uncontrolled well flow is challenging. Not only are proper actions needed, but proper communication, logging, and reporting are needed as well. Moreover, the challenge increases with the addition of multiple rigs and multiple levels of hierarchy needing different information simultaneously.

### BRIEF DESCRIPTION OF THE DRAWINGS

For a more complete understanding of the present disclosure, reference is now made to the accompanying drawings and detailed description, wherein like reference numerals represent like parts:

FIG. 1 illustrates a safety barrier alert system in accordance with at least some illustrative embodiments;

FIG. 2 illustrates a safety barrier alert client interface in accordance with at least some illustrative embodiments;

FIG. 3 illustrates a safety barrier alert method in accordance with at least some illustrative embodiments; and

FIG. 4 illustrates a particular machine suitable for implementing one or more embodiments described herein.

### NOTATION AND NOMENCLATURE

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean an optical, wireless, indirect electrical, or direct electrical connection. Thus, if a first device couples to a second device, that connection may be through an indirect electrical connection via other devices and connections, through a direct optical connection, etc.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one having ordinary skill in the art will understand that the following description has broad application, and the discussion of any embodiment is meant only to be exemplary of that embodiment, and not intended to intimate that the scope of the disclosure, including the claims, is limited to that embodiment.

The terms “barrier” and “safety barrier” are use interchangeably herein. A safety barrier is a component or practice that contributes to total drilling rig system reliability by preventing injury and fluid flow if properly deployed. A “verified” safety barrier is a safety barrier for which proper deployment has been confirmed through a post-installation test or through observations recorded during installation or post-installation. The terms “validated” and “verified” are used interchangeably herein. Such verification provides a high degree of assurance that the drilling rig is safe and fluid is contained. One way to evidence verification is with a drilling rig parameter that is within its intended range. “Invalidation” of a safety barrier is a violation of a protocol designed for the safety of the drilling rig or containment of fluid. The terms “invalidation” and “unverified” or “non-verification” are used interchangeably herein. One way to evidence non-verification is with a drilling rig parameter that is not within its intended range. Thus, a safety barrier is not necessarily a physical barrier but may also be an operational characteristic or method.

A system of multiple barriers is used to achieve a high level of reliability in avoiding uncontrolled flow during well construction, operation, and abandonment. The well reliability that is achieved is a function of the combined reliabilities of each individual barrier. The number and types of barriers used varies with the specific operation. In at least one embodiment, if an operation is performed with fewer than two barriers in place, then risk becomes critical.

There are several illustrative safety barriers including, but not limited to, the riser barrier, casing barrier, wellhead barrier, surface equipment barrier, blowout preventer barrier, cement barrier, and fluid or mud column barrier. Each will be discussed in turn.

For a subsea well, the riser (or marine riser) is a large-diameter pipe connecting a wellhead with a rig, and the main tubular section of the riser brings mud to the surface. As such, a riser may be hundreds or thousands of feet in length in order to traverse the depth of the sea. Other sections of the riser are used to house power and control lines for the blowout preventer (“BOP”). The riser barrier ensures that riser parameters stay within tolerable limits. Some parameters are:

The minimum and maximum allowable tension for safe operation of the riser. For drill pipe rigs, the minimum top tension provides sufficient tension at a connector between the lower marine riser package (“LMRP”) and blowout preventer (“BOP”) stack such that the LMRP is lifted off the BOP stack in an emergency disconnect situation. The minimum top tension also prevents buckling at the bottom of the riser. The maximum top tension is governed by drilling recoil;

The maximum weather conditions under which the riser can be run, retrieved, or hung-off;

Riser hang-off calculations at various water depths. The riser hang-off system provides structural support between tubes, such as the main tube and outer tube, and the riser hang-off system includes seals between tubes;

Fatigue analysis for the riser if high water currents are expected at the location. In some cases, risers are equipped with vortex-induced vibration (“VIV”) suppression devices (strakes or fairings) over the depth interval of the highest currents to achieve an acceptable riser system fatigue life;

Operating limits for tripping pipe or pipe rotation. Ensuring such limits begins by establishing the maximum allowable inclination at the wellhead. After the riser and BOP stack are run and latched to the wellhead, BOP inclination and riser angle sensor data from a lower flex joint or ball joint of the riser are monitored to ensure that the flex joint angle or angles do not exceed established limits;

Subsea currents acting on the riser. Such currents can affect the shape of the riser and cause increased wear. The use of loop current tracking services or acoustic Doppler current characteristics may be used for measuring water surface currents and current characteristics versus depth at a specific location;

Abnormal wear. During well operations, a ditch magnet is sometimes placed in the mud return flow path to collect steel particles. Daily weighing of the collected steel particles provides a way to detect abnormal wear in the riser. Additionally, all riser system components may be periodically inspected for internal wear as part of the riser safety barrier; and

Gas expansion. The solubility of gas in formation fluids and drilling mud increases with the pressure of the fluid, which is affected by the type of fluid system used. Synthetic-base mud (“SBM”) and oil-base mud (“OBM”) systems have higher gas solubility than water-base mud. In deepwater drilling and completion operations, detection of gas influx into the wellbore that goes into solution can be masked. The gas influx only becomes apparent when it starts breaking out of solution above the subsea BOP inside the drilling riser (e.g., from an increase in return flow rate or pit gain). In the riser, the bubble point may be above the BOP. Above the bubble point, gas forms bubbles and escapes the solution to become free gas. At this juncture, the rate of gas expansion can unload the contents of the riser. To prevent expanding gas from being vented onto the rig floor, a diverter system and its associated overboard vent lines provide a way to safely vent expelled mud and gas through the downwind vent lines away from the rig. As such, part of the riser safety barrier may include monitoring temperature, pressure, and rate of flow in the riser, diverter system, and vents.

The casing barrier is a tubular member installed and cemented in the well. The casing provides the foundation for a deepwater well and is designed to withstand two primary loads: axial, or bearing, load and bending load. Many factors account for the amount of axial and bending load the casing can withstand. One such factor is installation of the pipe. The most common method of installing structural pipe is jetting. Other structural installation methods include drilling, grouting, or driving using a subsea hammer. Jetting causes the greatest degradation in axial capacity because the jetted structural pipe must initially support its own weight. After the first riser-less casing string is cemented to the mud line and the cement has set, the axial load for the remainder of the well, including all casings and the BOP, is supported by the combined capacity of the two casing strings. Axial capacity is also dependent on soil strength and the disturbance to the soil as the conductor is jetted into place. The amount of disturbance depends on the rate of jetting (pumping) and time allowed for the soil to recover from jetting. Part of the casing barrier may include monitoring installation of the casing and periodic inspections to assess bearing load and bending load.

Some other parameters associated with the casing are:

Buckling. Buckling can be caused by thermal effects and mud weight changes. Buckling can be particularly severe when the casing passes into an enlarged hole size, such as a wash outs, or an enlarged holes below a previous casing shoe. As such, part of the casing barrier may include monitoring temperature and mud weight;

Casing thickness;

Connection wear. Metal-to-metal seals for connections are prone to wear, especially flush or semi-flush connections, which usually have a metal-to-metal seal on a formed pin that has a reduced inner diameter;

Abrasive solids in mud causing wear; and

Casing hardness. While drilling, magnets can recover steel cuttings, which can be measured, recorded, and plotted. Over time, wear can be measured. Additionally, the casing can be callipered or pressure tested to ensure that it remains a viable barrier.

Wellhead equipment is particularly susceptible to corrosions. However, the inner surfaces of subsea wellheads are protected by corrosion-preventative fluids and coatings such as zinc, manganese phosphate, or a fluoropolymer. High-pressure seal preparations are overlaid with alloys for additional corrosion protection. Corrosion effects can also be mitigated through the quality of paint used. As such, part of the wellhead equipment safety barrier may include monitoring corrosions, thickness of the corrosion-preventative fluids, and effectiveness of the seals.

Wellhead growth is the term used for axial movement of the wellhead relative to its initial position at the mud line. Wellhead growth is caused by the forces exerted on the wellhead by the tubulars hung in the wellhead and the pressure within the annuli created between the tubulars. These forces are caused by thermal stresses in the well casing.

The various types of surface equipment call for various checks to verify the surface equipment barrier. Some parameters and checks associated with the surface equipment barrier are:

All flanges connected and secure;

Instrument supply air connected;

Back pressure control valves tested;

Fluid dump valves tested;

Fluid turbine meters tested;

Isolation valves tested;

Choke manifold valves tested;

Test ball valves tested;

Equipment piping inspected;

Sight glasses inspected and cleaned;

Surface test tree pressure tested;

Surface safety valve pressure tested;

Flow line pressure tested;

Choke manifold pressure tested;

Surface separation equipment pressure tested;

Fluid lines pressure tested;

Flare, production, and vent lines pressure tested;

Pipe restraining system installed;

Air compressors tested;

Diesel, oil and water levels checked;

Flow rates and pressure outputs to burners tested;

Hoses tied;

Igniters positioned;

Burner nozzles cleaned and inspected; and

Propane bottles secured.

The BOP barrier is a system of hardware installed at the mud line above the subsea wellhead that is capable of sealing the open wellbore and sealing tubulars in the wellbore. The BOP includes high pressure choke lines, kill lines, choke valves and kill valves, and the barrier replaces the loss of hydrostatic pressure in the event of a riser disconnect. The subsea BOP incorporates multiple elements designed to close around different sizes of drill pipe, casing, or tubing used in well construction. The BOP main body is subjected to bending loads from the riser. As such, part of the BOP safety barrier may include monitoring pressure, loads, and the effectiveness of seals and valves.

Cement plugs located in the open hole or inside the casing/liner prevents fluid flow between zones or up the wellbore. For cement to serve as a barrier to the influx of formation fluids, the cement slurry density and additives may be monitored.

For a fluid column to serve as a barrier, the hydrostatic pressure of the fluid should exceed the pore pressure of the formation on which the pressure acts. Hydrostatic pressure is the pressure exerted by a fluid. Failure to maintain the fluid column height may cause a pressure underbalance and allow the formation to flow. The density of the fluid, and consequently the temperature profile of the well, may be monitored to maintain the overbalance.

Some other fluid column parameters are:

Block position;

Flow in;

Flow out;

Mud density in;

Mud density out;

Rotary speed;

Running speed; and

Total Gas.

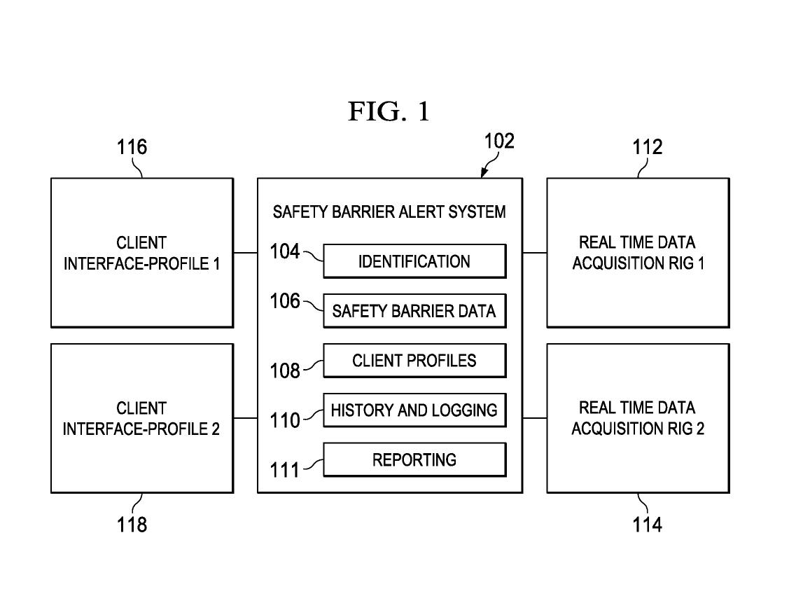

FIG. 1 illustrates a real-time monitoring and alert system 102 for safety barrier monitoring, alerting, and reporting. The alert system 102 is coupled to real time data acquisition components 112, 114 and client interface components 116, 118. The coupling may include a wireless, wired, or satellite connection and may occur through intermediate devices such as servers, routers, or switches. The connection may occur through channels such as the Internet. The real time data acquisition components 112, 114 may include sensors on one or more drilling rigs in at least one embodiment. The sensors may sense any of the safety barrier parameters described above the alert system 102 may keep track of time elapsed between various inspections. As illustrated, real time data acquisition component 112 is on one drilling rig (Rig 1) while real time data acquisition component 114 is on another drilling rig (Rig 2). As such, safety barrier alert system 102 receives drilling rig safety barrier data at safety barrier data component 106 from multiple rigs. The system 102 can be used to validate and monitor barriers throughout entire well lifecycles. As such, measures can be taken to prevent hazards that can give rise to major accidents involving release of potentially dangerous materials such as kicks or explosions. Indeed the system 102 can be part of the process safety of wells

An identification component 104 identifies when parameters are trending toward a safety barrier non-verification. For example, casing thickness should be above a threshold to keep the rig stable. The threshold is stored in the identification component 104. As the safety barrier data component 106 receives casing thickness data from Rig 1, the identification component 104 identifies that the threshold is being approached by comparing the incoming data to the stored threshold. Thus, the identification component 104 identifies an impending casing barrier violation, and assigns the impending casing non-verification a priority. In at least one embodiment, the priority assigned is based on a priorities labeled 1, 2, 3, 4, and 5, wherein 1 is the lowest priority and 5 is the highest priority. For example, the impending casing non-verification is assigned a priority of 4. Additionally, the safety barrier alert system 102 requests more casing thickness data or casing data in general from real time data acquisition 112. As a result, casing sensors previously dormant or incommunicative begin sensing or communicating as the impending non-verification approaches. In this way, data collection in moments of interest are detailed while resources are conserved for relatively normal performance.

Client profiles are stored in client profile component 108, Client profiles may be associated with particular persons or with particular positions. For example, a client profile may refer to a particular Vice President named John Smith. In this case, the profile would consist of personal and contact information for John Smith including rigs under his purview and safety barriers for which he is responsible or in which he is interested. A client profile may also refer to the position of Vice President and may include all Vice Presidents. In this case, the profile would consist of personal and contact information for a group of people including John Smith. As such, particular people or groups of people may be alerted of impending safety barrier non-verifications. Profiles for alert may include government regulator, chief of the drilling rig, on-shore monitor, company man, executive, and chief executive officer (“CEO”) in at least one embodiment. Custom profiles can also be created. Each profile may be interested in different data at different granularity. For example, the CEO may only be interested in priority 5 impending non-verifications, but for every well that the company services. Contrastingly, a chief of the drilling rig may be interested in impending non-verifications of all priorities, but only for one well. As such, these profiles may have different priorities assigned to them based on the same priority system as the impending non-verifications. For example, the priorities may be assigned as follows: government regulator-5, chief of the drilling rigs-1, on-shore monitor-2, company man-3, executive-4, and chief executive officer-5. As such, because the priority of the impending casing non-verification is assigned a priority of 4, the profiles identified for alert of the impending non-verification are chief of the drilling rig (1), on-shore monitor (2), company man (3), and executive (4) (i.e., 4 matches or exceeds 1, 2, 3, and 4). The alert may take various forms such as email, short messaging service (“SMS”), telephone call, or pop-up notification. Accordingly, the client interface 116, 118 may take various forms such as web browser, computer application, mobile phone application, or telephone.

Additionally, each profile may be associated with rules. For example, the chief of the drilling rig profile may contain a rule that he should be informed of impending non-verifications of any priority on his rig, but only priority 3 and higher non-verifications on other rigs. Similarly, the number of rigs associated with each profile can be varied and customized.

History and logging component 110 not only stores historical safety barrier data but logs interactions with the client interfaces 116 and 118. For example, in an embodiment the history and logging component logs events such as sign-in, sign-out, notification sent, and verification received. Such interactions provide a trail of evidence that can be used in regulatory reporting. Reporting component 111 formats the desired historical safety barrier data and relevant logged information into a report suitable for regulatory reporting as discussed in detail below. In at least one embodiment, regulators are given a profile and can thus access the system 102 via an interface 118, 116 for investigations.

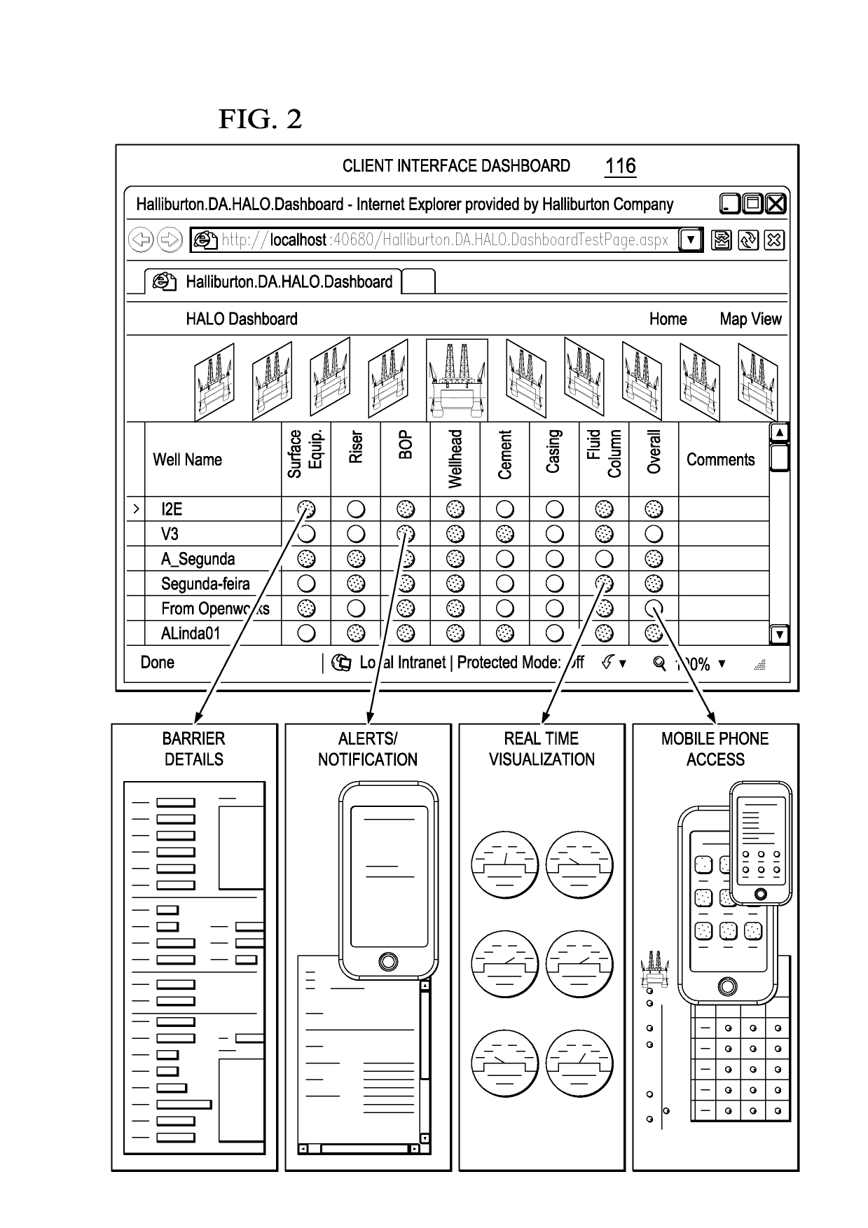

FIG. 2 illustrates a client interface 116 according to at least one embodiment. As illustrated, the interface 116 is displayed in a browser. The profile illustrated has access to view the status of multiple wells. The column on the left of the interface 116 identifies each rig by name. The subsequent columns represent the status of each safety barrier as well as an overall status in the column on the right of the interface 116. Detailed information can be seen by clicking various status indicators as illustrated by the call out boxes.

In at least one embodiment, a three-category system is used for visualization of safety barrier status and overall rig status. Specifically, the three-category system associates the colors green, yellow, and red to safety barriers or rigs. Green and yellow may represent compliance with the two-barrier principle, with yellow serving to highlight well-integrity anomalies in at least one embodiment. Red may be used to highlight wells that, in addition to failure of one barrier, have considerable degradation or failure of the second barrier. Yellow may also be used to highlight an impending non-verification. A grey status indicator means that particular safety barrier is not applicable or inactive for the well. The top of the interface 116 illustrates a pictorial view of each well; by selecting a picture, a particular well associate with the picture is selected for display of detailed real time information about the well. The level of detail different profiles can access is customizable. For example, on-shore monitors may only access information about a few wells in at least one embodiment, but may be able to drill down into very detailed safety barrier data regarding those wells. In at least one embodiment, a four-category system is used. Specifically, the four-category system associates the colors green, yellow, orange, and red to safety barriers or rigs. The orange status color may represent one barrier without degradation of a second barrier. The orange status color may also represent a safety barrier failure that may lead to a leak in an alternative embodiment.

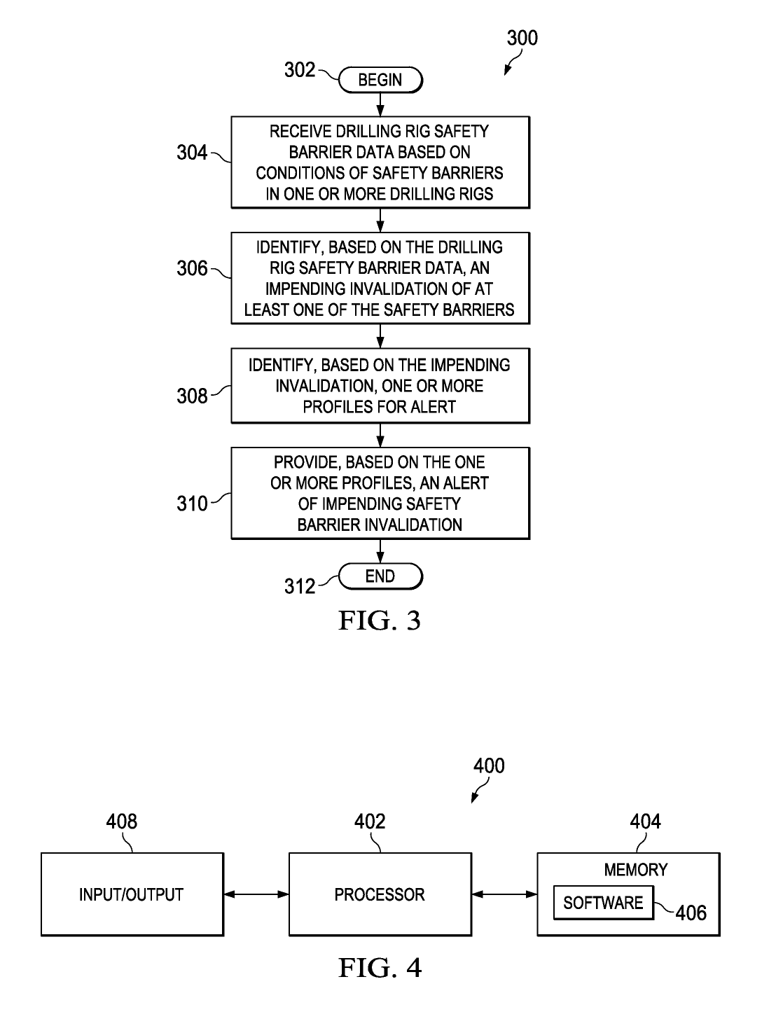

FIG. 3 illustrates a method 300 of safety barrier alert beginning at 302 and ending at 312. In at least one embodiment, the method 300 may comprise any steps discussed in this disclosure. At 304, drilling rig safety barrier data is received, for example, at a server. The data is based on conditions of safety barriers in one or more drilling rigs. At 306, an impending non-verification of at least one of the safety barriers is identified based on the drilling rig safety barrier data. In an alternative embodiment, a non-verification that already has occurred is identified. As a result, an increase in amount of drilling rig safety barrier data being received is requested based on the impending non-verification.

At 308, one or more profiles are identified for alert based on the impending non-verification. A priority may be assigned to the impending non-verification and various profiles. As such, one part of identifying the one or more profiles for alert may include identifying the one or more profiles based on the priority of the impending non-verification matching or exceeding the priorities of the potential profiles. At 310, an alert of impending safety barrier non-verification is provided based on the one or more profiles. Directions for verifying the at least one of the safety barriers may be provided based on the one or more profiles. In addition to proactive notification, the client interfaces for the affected profiles are updated. For example, a green status indicator changes to yellow for a particular safety barrier and rig. Confirmation of verification of the at least one of the safety barriers from input data associated with the one or more profiles may be received in at least one embodiment. A history of the at least one of the safety barriers may be provided as well.

As an example, a piece of surface equipment is required to be inspected once a month for verification of the surface equipment parameter. No verification has yet been received for this parameter from a rig inspector profile via a client interface, and the one month due date is approaching. The profile for the correct rig inspector is notified with directions on how the equipment is to be inspected. Upon logging into the client interface, the rig inspector is notified via a pop-up message. After performing the inspection, the rig inspector inputs his successful inspection via the client interface. Thus, the surface equipment safety barrier on this rig will not be invalidated for lack of inspection.

In at least one embodiment, a report may be generated for executive review of single or multiple safety barriers or wells, regulatory reporting for single or multiple safety barriers or wells, or as a hardcopy archive of single or multiple safety barriers or wells. The report may include well construction data in at least one embodiment. Some pieces of well construction data are:

Wellhead data with schematic;

Tree data with schematic;

Casing program (depths, sizes);

Casing and tubing data, including test pressures;

Cement data;

Fluid, tubing, and annuli status;

Wellhead pressure tests;

Tree pressure tests;

Completion component tests;

Perforating details; and

Equipment details such as identification or serial numbers.

From the description provided herein, those skilled in the art are readily able to combine software created as described with appropriate computer hardware to create a special purpose computer system and/or special purpose computer sub-components in accordance with the various embodiments, to create a special purpose computer system and/or computer sub-components for carrying out the methods of the various embodiments and/or to create a computer-readable media that stores a software program to implement the method aspects of the various embodiments.

In at least one embodiment, a non-transitory machine-readable storage medium comprises executable instructions that, when executed, cause one or more processors to perform any step described in this disclosure. FIG. 4 illustrates a computer system 400 in accordance with at least some embodiments, and upon which at least some of the various embodiments may be implemented. That is, some or all of the various embodiments may execute on a computer system such as shown in FIG. 4, multiple computers systems, and/or one or more computer systems equivalent to the FIG. 4 (such as scaled down computer systems for implementation in or within the onboard device), including after-developed computer systems.

In particular, the computer system 400 comprises a processor 402, and the processor couples to a main memory 404 by way of a bridge device. In some embodiments, the bridge device may be integrated with the processor 402. Moreover, the processor 402 may couple to a long-term storage device (e.g., a hard drive) by way of the bridge device. Programs 406 executable by the processor 402 may be stored on the storage device, and accessed when needed by the processor 402. The programs 406 stored on the storage device may comprise programs to implement the various embodiments of the present specification, including programs to calculate retrieve rules, retrieve data, and implement and command radiance efficiency measurement, including receiving input and displaying output via peripheral devices 408. In some cases, the programs 406 are copied from the storage device to the main memory 404, and the programs are executed from the main memory 404. Thus, both the main memory 404 and storage device are considered machine-readable storage mediums.

Barrier maintenance may include periodically verifying a barrier, which may include testing the barrier, inspecting the barrier, assessing failed barriers, testing crew competence (e.g. with drills), checking design criteria, and documenting any changes to the barrier.

In the specification, certain components may be described in terms of algorithms and/or steps performed by a software application that may be provided on a non-transitory machine-readable storage medium (i.e., other than a carrier wave or a signal propagating along a conductor). In many cases, such descriptions are intended to set forth the embodiments using representations that are used among those of skill in the arts. Accordingly, any descriptions that refer to algorithms, method steps, functional components, and the like, shall be considered to encompass electrical, magnetic, optical, and/or mechanical signals representing such algorithms, method steps, functional components, such signals being capable of being stored, input, output, and/or otherwise manipulated.

All such terms, and any similar terms, are to be considered labels only, and are intended to encompass any appropriate physical quantities or other physical manifestations. Any particular naming or labeling of the various modules, protocols, features, and the like is intended to be illustrative; other names and labels can be equivalently used. In addition, various terms such as “processing,” “calculating,” “determining,” “transmitting,” or the like, may be used herein. Such terms are intended to refer to processes performed by a software and/or hardware device such as a computer system. Such terms refer to various types of manipulation and/or transformation of physical and/or electronic components such as registers and memories within the device. These physical and/or electronic components typically represent data elements to be transformed, transmitted, and/or output.

Furthermore, the various aspects can be implemented as a method, system, computer program product, user interface, or any combination thereof.

The various embodiments also relate to a system for performing various steps and operations as described herein. This system may be a specially constructed device such as an electronic device, or it may include one or more particular machines that can follow software instructions to perform the steps described herein. Multiple computers can be networked to perform such functions. Software instructions may be stored in any computer readable storage medium, such as for example, magnetic or optical disks, cards, memory, and the like. For example, the different components 104, 106, 108, 110, 111 of the safety barrier alert system 102 may be different programs or threads on a single or multiple computers. In various embodiments, the responsibilities of each component may be separated or merged with another component on a single or multiple computers, each component may be implemented on the same computer, and each component may be implemented on separate computers.

The method steps, user interface layouts, displays, and other components described herein can be implemented on any computer, network, or other apparatus capable of performing the functions described. No limitation as to operation on a particular type of system or apparatus is implied. No particular programming language is required; rather, any type of programming language can be used to implement the various embodiments.

References to “one embodiment”, “an embodiment”, “a particular embodiment” indicate that a particular element or characteristic is included in at least one embodiment of the invention. Although the phrases “in one embodiment,” “an embodiment,” and “a particular embodiment” may appear in various places, these do not necessarily refer to the same embodiment.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A non-transitory machine-readable storage medium comprising executable instructions that, when executed, cause one or more processors to:
receive drilling rig safety barrier data based on conditions of safety barriers in one or more drilling rigs;
identify, based on the drilling rig safety barrier data, an impending invalidation of at least one of the safety barriers;
identify, based on the impending invalidation, one or more profiles for alert;
output, based on the one or more profiles, an alert of impending safety barrier invalidation.

2. The medium of claim 1, wherein the instructions cause the one or more processors to output, based on the one or more profiles, directions for validating the at least one of the safety barriers.

3. The medium of claim 1, wherein the instructions cause the one or more processors to request, based on the impending invalidation, an increase in amount of drilling rig safety barrier data, that is associated with the at least one of the safety barriers, being received.

4. The medium of claim 1, wherein the instructions cause the one or more processors to receive confirmation of validation of the at least one of the safety barriers from input data associated with the one or more profiles.

5. The medium of claim 1, wherein the instructions cause the one or more processors to output a history of the at least one of the safety barriers.

6. The medium of claim 1, wherein the instructions cause the one or more processors to assign a priority to the impending invalidation, assign the one or more profiles with another priority, and when the one or more processors identify the one or more profiles for alert, the instructions cause the one or more processors to identify the one or more profiles based on the priority matching or exceeding the another priority.

7. The medium of claim 1, wherein the at least one of the safety barriers comprises two safety barriers.

8. The medium of claim 1, wherein the at least one of the safety barriers is selected from the group consisting of: riser; casing; wellhead; surface equipment; blowout preventer; cementing; and fluid column.

9. A method, comprising:
receiving, at a drilling rig safety barrier server, drilling rig safety barrier data based on conditions of safety barriers in one or more drilling rigs;
identifying, based on the drilling rig safety barrier data, an impending invalidation of at least one of the safety barriers;
identifying, based on the impending invalidation, one or more profiles for alert;
providing, based on the one or more profiles, an alert of impending safety barrier invalidation.

10. The method of claim 9, further comprising providing, based on the one or more profiles, directions for validating the at least one of the safety barriers.

11. The method of claim 9, further comprising requesting, based on the impending invalidation, an increase in amount of drilling rig safety barrier data, that is associated with the at least one of the safety barriers, being received.

12. The method of claim 9, further comprising receiving confirmation of validation of the at least one of the safety barriers from input data associated with the one or more profiles.

13. The method of claim 9, further comprising providing a history of the at least one of the safety barriers.

14. The method of claim 9, further comprising assigning a priority to the impending invalidation and assigning priorities to the one or more profiles, wherein identifying the one or more profiles for alert comprises identifying the one or more profiles based on the priority matching or exceeding the priorities.

15. The method of claim 9, further comprising identifying, based on the impending invalidation, one or more profiles for alert selected from the group consisting of: government regulator; chief of the one or more drilling rigs; on-shore monitor; company man; executive; and chief executive officer.

16. The method of claim 9, wherein the at least one of the safety barriers is selected from the group consisting of: riser; casing; wellhead; surface equipment; blowout preventer; cementing; and fluid column.

17. A system, comprising:
one or more processors;
memory coupled to the one or more processors, the memory storing executable instructions that when executed by the one or more processors, cause the one or more processors to:
receive drilling rig safety barrier data based on conditions of safety barriers in one or more drilling rigs;
identify, based on the drilling rig safety barrier data, an impending invalidation of at least one of the safety barriers;
identify, based on the impending invalidation, one or more profiles for alert;
output, based on the one or more profiles, an alert of impending safety barrier invalidation.

18. The system of claim 17, wherein the instructions cause the one or more processors to output, based on the one or more profiles, directions for validating the at least one of the safety barriers.

19. The system of claim 17, wherein the instructions cause the one or more processors to request, based on the impending invalidation, an increase in amount of drilling rig safety barrier data, that is associated with the at least one of the safety barriers, being received.

20. The system of claim 17, wherein the instructions cause the one or more processors to assign a priority to the impending invalidation, assign priorities to the one or more profiles, and when the one or more processors identify the one or more profiles for alert, the instructions cause the one or more processors to identify the one or more profiles based on the priority matching or exceeding the priorities.
